(19) United States
(12) Patent Application Publication
(10) Pub. No.: US 2020/0106791 A1
(43) Pub. Date: Apr. 2, 2020

(54) INTELLIGENT SYSTEM FOR MITIGATING CYBERSECURITY RISK BY ANALYZING DOMAIN NAME SYSTEM TRAFFIC METRICS

(71) Applicant: FireEye, Inc., Milpitas, CA (US)

(72) Inventors: Ken BAGNALL, County Kildare (IE); Ralph CASEY, Leopardstown Dublin 18 (IE); John JENSEN, Nova Scotia (CA)

(21) Appl. No.: 16/146,233

(22) Filed: Sep. 28, 2018

(51) Int. Cl. H04L 29/06; H04L 12/58; H04L 29/12; G06F 11/30

(52) U.S. Cl. CPC H04L 63/1425; H04L 63/1441; H04L 51/30; G06F 2201/81; G06F 11/3006; G06F 2201/875; G06F 2201/88; H04L 61/1511

(57) ABSTRACT

A system, method and computer-readable medium for mitigating cybersecurity risk by analyzing domain name system (DNS) traffic metrics, including detecting a network communication propagated over a computer network, the network communication comprising a domain identifier, determining DNS traffic metadata corresponding to the domain identifier, the DNS traffic metadata being determined based on monitored DNS traffic associated with the domain identifier to one or more DNS servers, the DNS traffic metadata comprising a count of DNS queries associated with the domain identifier and a rate of DNS queries associated with the domain identifier, determining whether the count of DNS queries and the rate of DNS queries are indicative of a cybersecurity risk, and activating one or more mitigation actions based at least in part on a determination that the count of DNS queries and the rate of DNS queries are indicative of a cybersecurity risk.

### BACKGROUND

The problem of cyber-attacks in enterprise networks is a pervasive and highly publicized topic. Common vectors of attack on enterprise networks include email-based attacks (e.g., phishing attacks, etc.), web content (e.g., automated scripts), and file-based attacks, etc. Cyber-attacks may exploit known or unknown security vulnerabilities including software, system, and human vulnerabilities. In some situations, an attack may be perpetrated by malware, which is a program, file, or digital data object e.g., through a malicious object embedded within content and designed to adversely influence (i.e., attack) normal operations of a computer. Examples of different types of malware include bots, computer viruses, worms, Trojan horses, spyware, adware, or any other programming that operates within the computer without permission.

In other situations, persons looking to infiltrate a network or steal sensitive data have utilized a method known as phishing. A phishing attack comprises the transmission of an electronic communication, such as an email, to a targeted recipient or a broad group of recipients. A phishing email purports to be from a known institution, such as a bank or credit card company, and appears to have a legitimate purpose. The communication can mimic the appearance of a legitimate email from the known institution, such as, by including logos, trade names, or other identifiers that lead the recipient to believe the email is authentic. Embedded in the phishing email is a Uniform Resource Locator (URL) that directs the recipient to a website requesting the recipient to enter credential information, such as for the purpose of changing their password. The phishing attack is completed when the recipient of the email enters (i.e. submits) credential information to the website, which is then delivered to the author of the phishing attempt, who may then use stolen credentials to obtain unauthorized access to recipient(s) accounts or other resources.

While email is an important and necessary means of communication in business, it is inherently insecure for a variety of reasons. Many email systems have no built-in mechanism for verifying that an email was sent from the sender it claims to be sent from. Furthermore, human error (i.e. user error) is a major threat to a company's information technology (IT) infrastructure as it often opens or represents a security vulnerability in the infrastructure. These vulnerabilities subject enterprise networks to the possibility of a cyber-attack through malware and phishing attacks. Consequently, malware can infect endpoints, deleting and/or extracting information, hold user information hostage (through encryption), and damage network connected resources. To protect the network computer resources of enterprises, cybersecurity vendors, such as FireEye, Inc., develop cybersecurity risk detection and mitigation products and services.

The Domain Name System (DNS) is a hierarchical decentralized naming system for any hardware or software resources connected to a network, such as the Internet. DNS associates various items of information, such as Internet Protocol (IP) addresses, with domain names assigned to each of the participating entities.

In cybersecurity, passive DNS systems can be used to identify cyberattacks. Passive DNS systems connect to a plurality of recursive name servers (rNS), request DNS information, such as IP addresses, associated with domains identified by the rNS, and store this DNS information in individualized entries of a log. Based on the DNS information collected by the passive DNS system, a security researcher can, for example, identify relationships between the DNS information of different log entries by studying and mining the data.

Unfortunately, there are several drawbacks with the passive DNS approach for cybersecurity monitoring. Since passive DNS monitoring typically stores DNS records as individual data records and typical network traffic can result in thousands of DNS queries per day, the physical resources (in terms of hardware and software) required to store and maintain this data for any useful period of time are significant. Additionally, because the data is stored in individual data entries, analysts cannot easily deduce relationships between the various entries that may correspond to similar DNS information in a timely fashion, thereby limiting the opportunity for mitigation of any detected cybersecurity risks.

More significantly, the current approach of passive DNS monitoring is a highly interactive, manual, and time-consuming process that is completely unsuited to dynamic risk monitoring and mitigation. For example, a passive DNS system encountering a new domain name or new DNS information pertaining to a domain name would not be able to analyze the DNS information and determine and implement a timely mitigation.

Additionally, conventional passive DNS systems have no effective way for identifying suspicious domains in real-time which have not previously been black listed, such as newly observed domains or domains that were previously accepted but have been compromised and are now being used to propagate malware.

Accordingly, improvements are needed in DNS systems for cyber-attack detection, prevention, and mitigation in a computer network.

### BRIEF SUMMARY OF THE INVENTION

The inventors have discovered a novel, automated, method, apparatus, and computer-readable medium for mitigating cybersecurity risk by analyzing domain name system (DNS) traffic rate and count. The intelligent system disclosed herein utilizes collected DNS query information pertaining to a particular domain identifier in a detected network communication to make real-time assessments of cybersecurity risks posed by the network communication and to implement real-time mitigation actions when a cybersecurity risk is detected.

The system accomplishes this real-time assessment and mitigation by continuously updating DNS metadata records corresponding to detected domain identifiers within network communications with aggregated DNS query count information based upon monitored DNS traffic relating to the detected domain identifiers. The system also dynamically tracks the rate of DNS queries associated with each domain identifier by using a revolving queue structure that stores DNS queries detected within limited time windows and deletes DNS queries outside of the limited time window.

The DNS query count and DNS query rate information corresponding to a detected domain identifier is then utilized to determine the cybersecurity risks posed by a detected network communication containing the detected domain identifier and to implement appropriate mitigation actions if the cybersecurity risk exceeds certain cybersecurity risk thresholds.

DNS traffic metadata, including DNS query count information, corresponding to detected domain identifiers is stored in DNS metadata records that are accessed using record identifiers that are generated from the monitored DNS traffic corresponding to the detected domain identifiers. This storage structure makes it possible for the system to utilize monitored DNS traffic to accurately and quickly perform lookup operations for aggregate information corresponding to a particular detected domain identifier, while at the same time updating the relevant DNS metadata records with newly detected DNS traffic. The monitored DNS traffic serves the dual purpose of providing the data which is used to update aggregate information in the DNS metadata record and also providing the data which is used to query the DNS information database for information from the relevant DNS metadata records.

The intelligent system disclosed herein therefore provides the novel solution of utilizing DNS network traffic metrics, including DNS query count and DNS query rate, corresponding to a domain identifier to make an assessment of cybersecurity risk for detected network communications (i.e., any communications involving a monitored device or component) that contain that domain identifier.

The intelligent system for mitigating cybersecurity risk by analyzing DNS traffic disclosed herein improves upon passive DNS monitoring systems. Unlike passive systems that can only be used manually by security analysts, the present system provides an action platform that continually ingests DNS traffic to maintain aggregate information relating to domain identifiers and then utilizes that aggregate information in real-time to detect and mitigate cybersecurity risks stemming from network communications containing domain identifiers. The present system can therefore be utilized for timely detection and mitigation of cybersecurity attacks from a variety of cybersecurity attack vectors in real-time, including email messages, web content, or any other type of network communication.

Furthermore, the use of DNS query count and DNS query rate metrics to detect cybersecurity risk for a particular domain identifier allows for the detection of cybersecurity threats from domains that have not previously been designated as suspicious (e.g., a domain in a black list), domains that have not previously been observed (e.g., domains encountered for the first time that are being used for a cyberattack), or domains that have previously been designated non-suspicious but which have since been compromised (e.g., a domain with a suspicious spike in DNS queries over a previous time period).

### BRIEF DESCRIPTION OF THE DRAWINGS

FIG. 1 illustrates the system for mitigating cybersecurity risk and components that communicate with the system according to an exemplary embodiment

FIG. 2 illustrates an example of a table 200 in the DNS database according to an exemplary embodiment.

FIGS. 3A-3B illustrate the revolving queue data structure used to track rates of DNS queries associated with a domain identifier according to an exemplary embodiment.

FIG. 4 illustrates a process for determining whether a DNS query count and DNS query rate are indicative of a cybersecurity risk according to an exemplary embodiment.

FIG. 5 illustrates a message flow diagram between components of the system for mitigating cybersecurity risk by analyzing DNS traffic rate and count according to an exemplary embodiment.

FIG. 6 illustrates a flowchart for cybersecurity risk assessment and mitigation according to an exemplary embodiment.

FIG. 7 illustrates an exemplary computing environment that can be used to carry out methods for mitigating cybersecurity risk by analyzing DNS traffic rate and count according to an exemplary embodiment.

### DETAILED DESCRIPTION

While methods, apparatuses, and computer-readable media are described herein by way of examples and embodiments, those skilled in the art recognize that methods, apparatuses, and computer-readable media for mitigating cybersecurity risk by analyzing domain name system (DNS) traffic rate and count are not limited to the embodiments or drawings described. It should be understood that the drawings and description are not intended to be limited to the particular forms disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “can” is used in a permissive sense (i.e., meaning having the potential to) rather than the mandatory sense (i.e., meaning must). Similarly, the words “include,” “including,” “includes”, “comprise,” “comprises,” and “comprising” mean including, but not limited to.

As discussed above, improvements are needed in DNS monitoring systems for cyber-attack detection, prevention, and mitigation in a computer network. Applicant has discovered novel methods, apparatuses, and computer-readable media for utilizing DNS traffic metadata pertaining to domains within network communications to assess the cybersecurity risk from the network communications that contain those domains. Applicant has additionally developed novel DNS traffic aggregation and storage structures that track DNS traffic metadata relating to DNS traffic associated with identified domains and enables a cyberattack detector unit (or module) to determine, in real-time, both the count of previous DNS queries pertaining to a domain and a rate of previous DNS queries over a predefined time period, and to use these metrics to assess cybersecurity risk for the new network communications.

The disclosed methods, apparatuses, and computer-readable media not only reduce the overhead (in terms of hardware and software resources) required to store meaningful DNS data, they also enable significantly faster computation of risk profiles of network communications. Unlike previous passive DNS systems that store records corresponding to each occurrence of DNS traffic, uncoupled from any structure that allows for aggregation, the present system utilizes a DNS metadata record that stores DNS traffic counts corresponding to previous DNS traffic associated with a particular domain and additionally utilizes a revolving queue structure that enables determination of a DNS traffic rate associated with a particular domain. This DNS traffic count and DNS traffic rate information are used, in real-time, as new network communications associated with that domain are detected, to assess cybersecurity risk. This real-time assessment of cybersecurity risk, in turn, enables automated and dynamic risk mitigation strategies at the time of receipt of a network communication, and not in hindsight, by an analyst, after a cyber-attack has already occurred.

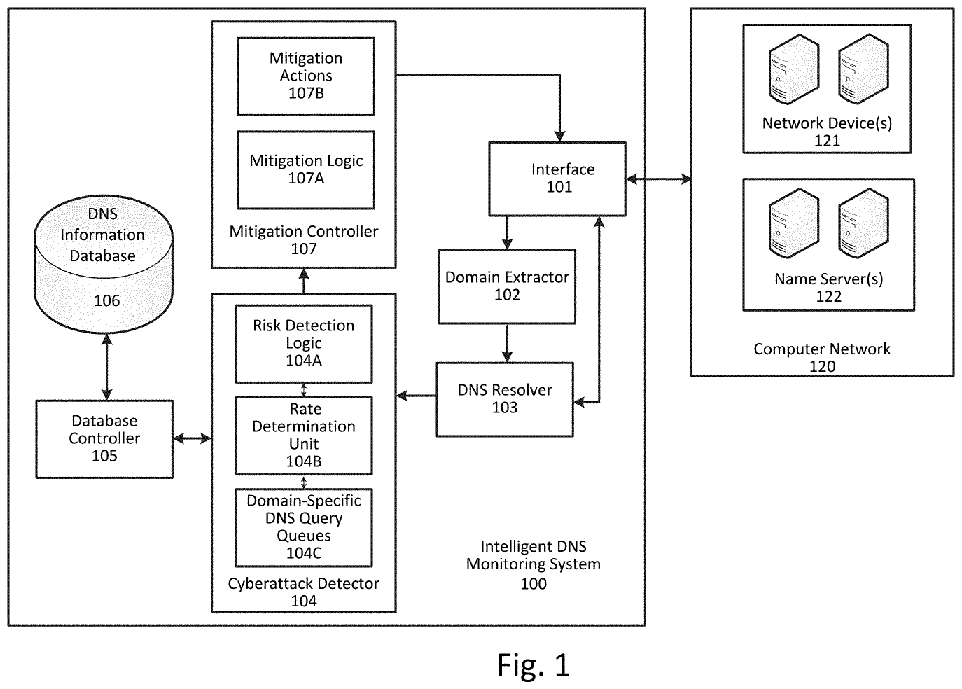

FIG. 1 illustrates an intelligent DNS monitoring system 100 for mitigating cybersecurity risk by analyzing domain name system (DNS) traffic rate and count according to an exemplary embodiment.

Intelligent DNS Monitoring System 100 includes an interface 101 that is configured to monitor network traffic in a computer network 120. Interface 101 is a network interface that detects network communications to and from devices within the computer network 120, such as network communications sent between network devices 121. Network communications include, for example, Simple Mail Transfer Protocol (SMTP) handshake requests transmitted between network devices 121, SMTP email messages transmitted between network devices 121, and/or a web browser requests transmitted between network devices 121. The interface 101 can be configured to monitor to one or more types of network communications (e.g., SMTP messages) and to detect any new network communications that fall within one of the monitored types of network communications.

Interface 101 additionally sends and receives information to and from components of the intelligent DNS monitoring system 100 and devices on the computer network 120, including name servers 122 storing DNS information. In this way, interface 101 serves as the intermediary routing mechanism for messages and data exchanged between the intelligent DNS monitoring system 100 and devices on the computer network 120.

Intelligent DNS Monitoring System 100 includes a domain extractor 102 that receives monitored network communications from interface 101 and includes a parser for parsing the text of the monitored network communications (or a copy of the monitored network communications) and an extractor for identifying and extracting domain identifiers from the monitored network communications. Multiple parsers and extractors can be used for different types of communications. For example, an SMTP parser can interpret SMTP commands and values within an SMTP message and identify a domain identifier within an SMTP messages based upon the interpreted text. Similarly, a transmission control protocol/internet protocol (TCP/IP) parser can interpret TCP/IP messages and extract domain identifiers from those messages. The parsed domain identifier can be in a header of the network communication, in a particular command or message (such as an SMTP command or TCP/IP message) or in the body of the network communication (such within a Uniform Resource Locator (URL) with an email body).

Intelligent DNS Monitoring System 100 further includes a DNS resolver 103 that is configured to receive the extracted domain identifier from the domain extractor 102 and transmit one or more DNS queries, via interface 101, to one or more name servers 122 in computer network 120. The DNS queries include the received domain identifier and a requested DNS record type, such as an address mapping A record, an AAAA record, a Canonical Name (CNAME) record, a Mail Exchange (MX) record, a text (TXT) record, a Name Server (NS) record, or a host information (HINFO) information record.

The one or more name servers 122 resolve the DNS queries and return, via the interface 101, one or more responses corresponding to the one or more DNS queries to the DNS resolver 103. The response returned to the DNS resolver includes a DNS response value corresponding to the DNS record type which is being requested. For example, a request for MX records will return a DNS response value that is a mail server address. After receipt of the one or more responses, the monitored DNS traffic information, including the DNS queries and the corresponding responses, are then provided to the cyberattack detector 104, along with the relevant domain identifiers.

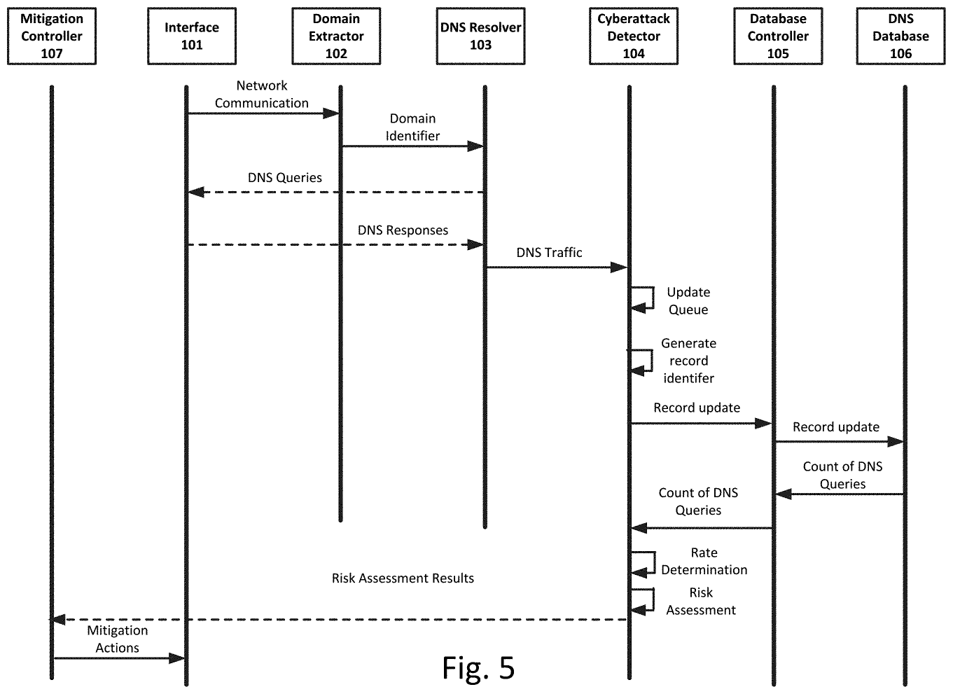

Cyberattack detector 104 includes a risk detection logic 104A component that is configured to extract information from the monitored DNS traffic to generate a record identifier. The process for extraction of information and generation of the record identifier is explained in greater detail with respect to FIG. 5, but generally involves the creation of a record identifier based on at least the domain identifier and optionally also a DNS record type and/or DNS response value in the monitored DNS traffic.

Cyberattack detector 104 then updates a DNS metadata record associated with the record identifier that is stored in a memory of the intelligent DNS monitoring system 100. The DNS metadata record can be stored in any type of data structure, such as a relational or structured database, a semi-structured database, or an unstructured database (such as a NoSQL database). The DNS metadata record can also be stored in any type of underlying file system. For example, the file system can be a disk based file system such as a File Allocation Table (FAT) file system or a flash file system built upon flash memory.

In the embodiment shown in FIG. 1, the DNS metadata records are stored in a DNS information database 106 which can be a structured relational database (such as a structured query language database) or an unstructured database. The update request from the cyberattack detector 104 is routed through the database controller 105 to the DNS information database 106, where it is then applied to update the DNS metadata record corresponding to the record identifier. For example, the DNS metadata record can be updated with an incremented count of DNS queries associated with a particular domain as a result of monitored DNS traffic.

The update request itself can include the record identifier in order to enable the database controller 105 and/or DNS information database 106 to locate the appropriate DNS metadata record for updating. Additionally, the update request can be an “upsert” request—i.e., a request to update existing records or insert new records where no prior record exists.

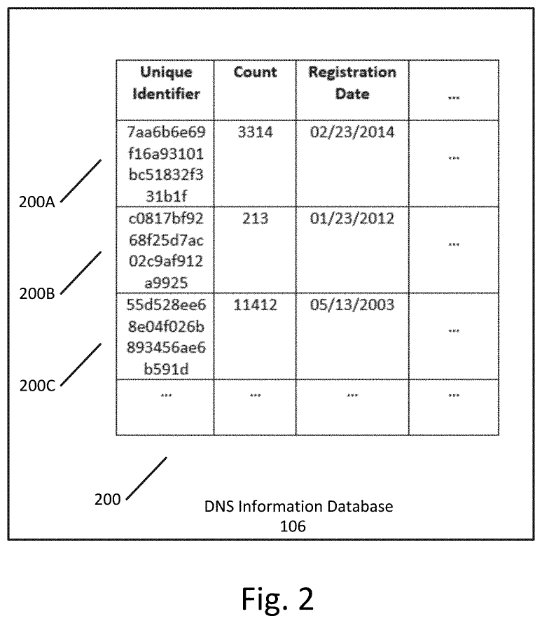

Examples of DNS metadata records are illustrated in FIG. 2, which shows an example of a table that can be stored in the DNS Information Database. As shown in FIG. 2, table 200 includes DNS metadata records 200A, 200B, and 200C, corresponding to columns of the table 200. Each of the DNS metadata records includes a record identifier that is generated based at least in part on a domain identifier, as well as one or more DNS traffic metrics associated with instances of the domain identifier in previous DNS traffic. For example, DNS metadata records 200A-200C include the DNS traffic metrics of a count of previous DNS queries transmitted relating to the domain identifier and a date of registration of a particular domain corresponding to each record identifier.

Of course, these DNS traffic metrics are provided for illustration only and other types of occurrence metrics can be utilized. Other examples of DNS traffic metrics that can be stored in the DNS metadata records include an initial date of detection that records the date when DNS traffic pertaining to a particular domain was monitored, a date range corresponding to each record identifier that indicates a date range associated with the corresponding DNS traffic, a quantity of prior updates to the DNS metadata record, a rate of updates to the DNS metadata record during a time period, and/or an inactivity period corresponding to each record identifier that tracks time period since corresponding DNS traffic was detected. DNS traffic metrics that rely on time periods can be determined based on timestamps associated with each occurrence of a particular domain identifier stored in the DNS information database. These additional metrics may be used by the system in conjunction with the DNS query rate and DNS query count or as an alternative in some embodiments.

These examples are not intended to be limiting, and the DNS traffic metrics stored for each DNS metadata record can be customized and configured by end-users, such as system administrators.

DNS traffic metrics are updated continuously, periodically, or “on-the-fly” as new DNS traffic pertaining to a particular domain identifier is monitored.

Each DNS metadata record including each of the DNS traffic metrics can optionally correspond to a type of DNS record. In this case, each DNS traffic metric is updated based on DNS traffic associated with the corresponding type of DNS record. This allows for aggregation of DNS traffic metrics corresponding to different types of communications separately. For example, DNS queries pertaining to email traffic related to a domain can be aggregated separately from DNS queries pertaining to web traffic related to a domain in spite of the fact that they are associated with the same domain.

Table 200 is provided only as an example of a table in the DNS information database 106 and the fields and columns shown therein are not intended to be limiting. The DNS database can store, track, and/or aggregate any data or metadata relating to monitored DNS traffic or detected network communications, or gathered from additional domain information data sources on the network. Of course, the data and metadata stored and aggregated by the DNS information database 106 can be stored in a single table, across multiple database tables, or in another format such as a semi-structured data records.

Returning to FIG. 1, the cyberattack detector 104 (and the risk detection logic 104A) is also configured to receive at least a portion of the updated DNS traffic metadata record from the DNS information database 106 via database controller 105. This received portion includes the count of DNS queries associated with the domain identifier in the DNS metadata record.

The receipt of the portion of the updated DNS metadata record can be in response to the update request sent by cyberattack detector 104. For example, the update request can include a request to return a portion or all of the information stored in the DNS metadata record being updated.

The receipt of the portion of the updated DNS metadata record can alternatively be in response to a separate query request sent from the cyberattack detector 104 to the DNS information database 106 (via database controller 105) after the update request. In this case, the query request can use the same record identifier previously generated for the update request to query the DNS information database for some or all of the fields in a particular DNS metadata record.

Cyberattack detector 104 additionally includes a rate determination unit 104B that generates the rate of DNS queries associated with the domain identifier by counting a quantity of records in a corresponding revolving queue in the stored domain-specific DNS query queues 104C. Each of the queues in the domain-specific DNS query queues 104C stores records corresponding to previous DNS queries associated with a particular domain identifier over a prior time period.

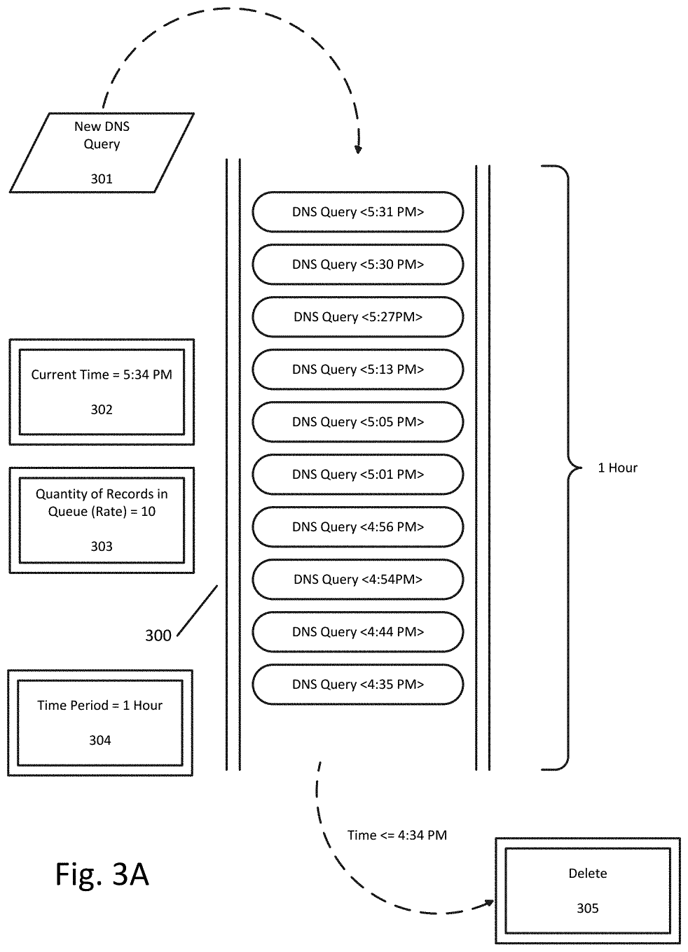

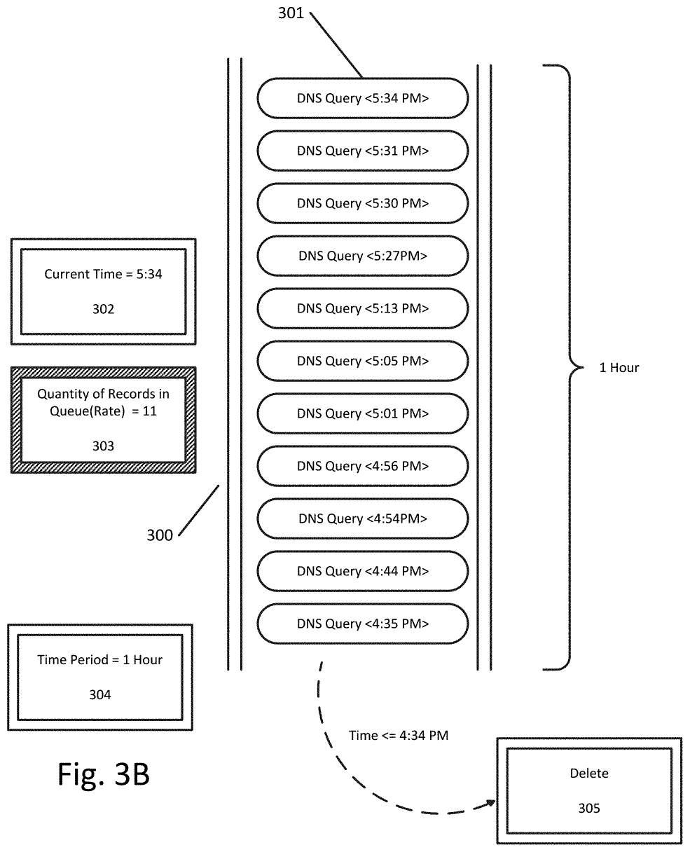

FIGS. 3A-3B illustrate the revolving queue data structure used to determine rates of DNS queries associated with a domain identifier according to an exemplary embodiment.

FIG. 3A illustrates a revolving queue 300 used to track a rate of DNS queries associated with a domain identifier. As shown in FIG. 3A, a new DNS query 301 has been detected but not yet added to the queue 300. The state of the queue 300 corresponds to a current time of 5:34 PM, as indicated in box 302. Since the time period 304 is set to one hour, the queue spans the previous hour (up to 4:35 PM) and only DNS queries that have been received in the past hour are stored in the queue 300.

The prior time period 304 used to limit the number of entries in the queue can be determined based upon one or more of administrator input, a default value, or the particular domain identifier. For example, a default global time period (e.g., 3 hours) can be set for the entire system, with different time periods being defined for specific domains (e.g., “gmail.com” has 30 minute time period”). In this case, the time period defaults to the global value unless some other time period has specifically been identified for a particular domain.

Each DNS query in the queue 300 has an associated timestamp, which is used to determine when to remove DNS queries from the queue 300. DNS queries that are older than 1 hour are deleted, as shown at step 305. In this case, that includes any DNS queries with a timestamp of less than or equal to 4:34 PM.

The rate of DNS queries for a particular domain identifier can be determined by the rate determination unit 104B by counting the number of queries in the queue 300 at any given time. In the instant shown in FIG. 3A (prior to the new DNS query 301 being added to the queue 300), the quantity of records in the queue is 10, as shown in box 303.

FIG. 3B illustrates the queue 300 after the new DNS query 301 is added to the queue 1508. As shown in FIG. 3B, since no DNS queries have been deleted from the queue, this results in a quantity of records in the queue of 11, as shown in box 303.

Of course, the queue 300 shown in FIG. 3 is an example only and other data structures can be utilized that track the count of DNS queries pertaining to a particular domain over a predetermined prior time period. Additionally, each queue can further be customized to not only a particular domain but also a DNS record type. In this case, each queue can store DNS queries of a particular type pertaining to a domain over a prior time period. This allows for the determination of a rate of DNS queries for different categories of DNS queries (such as DNS queries pertaining to MX record lookups versus DNS queries pertaining to A record lookups).

Turning back to FIG. 1, the rate determination unit 104B determines the rate of DNS queries associated with the domain based on a corresponding queue in the domain-specific DNS query queues 104C. Since each queue is only maintained for the length of the determined time period, the count of record in each queue indicates the number of DNS queries corresponding to the domain that have occurred over the most recent prior time period equal to the determined time period.

In an alternative implementation, the rate determination unit 104B and the domain-specific DNS query queues 104C can be located in a different component of the intelligent DNS monitoring system. For example, the rate determination unit 104B can be part of the database controller 105 and the domain-specific DNS query queues 104C can be stored in the DNS information database 106. In this implementation, the risk detection logic 104A can retrieve the rate information as part of the update request or as a query to the DNS information database 106, and the database controller 105 can utilize the rate determination unit 104B to determine the count of queries in a corresponding queue in the domain-specific DNS query queues 104C stored in the DNS information database. In another implementation, the rate determination unit 104B can be part of the database controller 105 and the domain-specific DNS query queues 104C can also be stored in a separate area of memory accessible to the database controller 105.

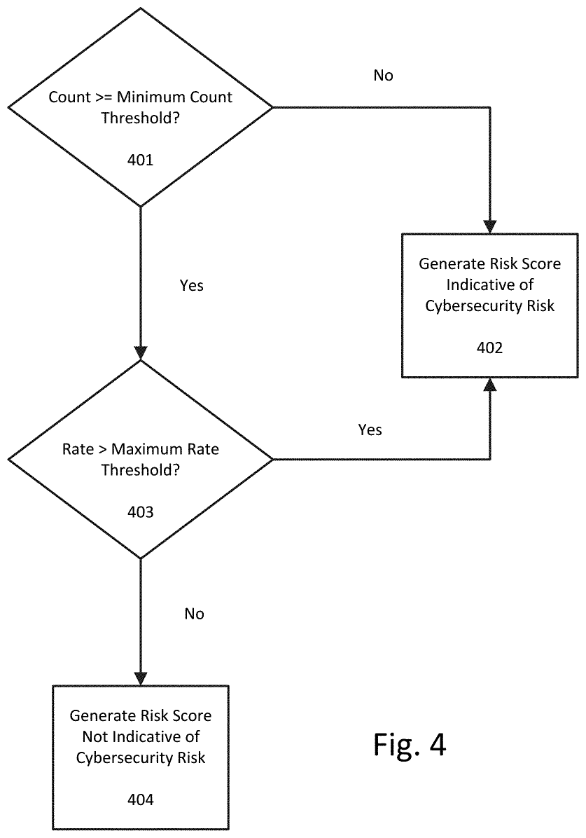

The risk detection logic 104A is configured to use the DNS query count and the DNS query rate information to make an assessment regarding cybersecurity risk. This process is described in greater detail with respect to FIG. 4, which illustrates the process for determining whether a DNS query count and DNS query rate are indicative of a cybersecurity risk according to an exemplary embodiment

At step 401 a determination is made regarding whether the DNS query count is greater than or equal to a minimum count threshold. This minimum count threshold can be set by a system administrator, can be set to some default value (e.g., 1000 DNS queries), and/or can be determined automatically based on the total volume of DNS queries detected by the monitoring system. For example, the minimum threshold can be determined based upon an average across all domains tracked by the system. The minimum threshold evaluation serves to detect network communications from sources that have not been previously observed or that have infrequently transmitted communications, as these communications may contain malware, spam, or phishing attempts.

If the count of DNS queries is less than the minimum threshold, then at step 402 a risk score that is indicative of cybersecurity risk is generated at step 402. This risk score can quantify the degree to which the count of DNS queries is less than the minimum threshold and can be used to determine the appropriate mitigation action. Otherwise, if the count of DNS queries is greater than or equal to the minimum threshold, then the process proceeds to step 403.

At step 403 it is determined whether a rate of DNS queries associated with the domain identifier exceeds a maximum rate threshold. The maximum rate threshold can be determined based at least in part on the count of DNS queries and the relevant time period. As discussed below, the relevant time period can be set by a user/administrator, set to some default value (e.g., 3 hours), or can be determined based upon the domain identifier.

The maximum rate threshold can be determined based at least in part on the count of DNS queries determined to be associated with the domain identifier. The maximum rate threshold indicates the maximum number of occurrences of a particular DNS query that are permitted within the time period before a network communication containing the domain identifier will be designated as being indicative of a cybersecurity risk. The maximum rate threshold is useful in identifying cybersecurity risks posed by domains that have not previously been flagged as suspicious (i.e., blacklisted) or that may previously have communicated with the protected system for legitimate purposes but have since been compromised. For example, a spike in the rate of DNS queries associated with a particular domain identifier can indicate suspicious activity, even if the domain identifier would by itself be considered benign (i.e., multiple attempts to propagate malware from an infected domain that would normally not be considered a threat).

The maximum rate threshold can be determined in a variety of ways. For example, the count of DNS queries associated with the domain identifier in the DNS database can set to be the maximum rate threshold. For example, if there were 3,459 DNS queries for a particular domain identifier, then the maximum rate threshold would be set to 3,459. The maximum rate threshold can also be determined as a function of the count of DNS queries in the DNS database. For example, the maximum rate threshold can be a fraction of the count of DNS queries in the DNS database (e.g., 1/10) or some multiple of the count of DNS queries in the DNS database (e.g., 10×). The parameters used to determine the maximum rate threshold can be set or provided by a user/administrator.

The relevant time period and a maximum rate threshold can be determined periodically for a particular domain identifier (e.g., annually, monthly, weekly, etc.) or one time in a system setup phase. Alternatively, the relevant time period and maximum rate threshold can be determined dynamically each time a cybersecurity risk assessment is made.

If the rate of DNS queries exceeds the maximum rate threshold, then the process proceeds to step 402 where a risk score is generated that is indicative of a cybersecurity risk. This risk score can quantify the degree to which the rate of DNS queries is greater than the maximum rate threshold and can be used to determine the appropriate mitigation action. Otherwise, if the rate of DNS queries is less than or equal to the maximum rate threshold, then the process proceeds to step 404 where a risk score is generated that is not indicative of a cybersecurity risk.

As will be discussed further below, the generated risk score in steps 402 or 404 can be used to determine whether to take a mitigation action and the severity of the mitigation action. Since the risk score can capture whether the thresholds are met and the degree to which they are not met, the risk mitigation action taken can be dependent on one or more of whether the count of DNS queries does not exceed or meet the minimum threshold, whether the rate of DNS queries exceeds the maximum rate threshold, the degree to which the count of DNS queries does not meet the minimum threshold, and/or the degree to which the rate of DNS queries exceeds the maximum rate threshold. For example, more severe mitigation actions (e.g., blocking communications) can be taken when the rate threshold far exceeds the maximum rate threshold and less severe mitigation actions (e.g., quarantining or flagging communications) can be taken when the rate threshold only slightly exceeds the maximum rate threshold.

Returning to FIG. 1, cyberattack detector 104 provides the results of the risk assessment analysis to mitigation controller 107, which includes mitigation logic 107A that is configured to determine whether to activate any mitigation actions 107B based upon the results, determine which mitigation actions 107B to activate, and implement the selected mitigation actions 107B. Results that are passed to the mitigation controller can include, for example, any risk scores that exceed a corresponding threshold and/or an indication of the degree to which a risk score exceeds a corresponding threshold, or an aggregate score computed by statistically combining or selecting individual scores resulting from the application of risk assessment rules pertaining to the DNS query count and the DNS query rate (such as, for example, the risk score for the DNS query count and a separate risk score for the DNS query rate)

The mitigation actions 107B that are selected for activation can optionally be linked to specific risk assessment rules. For example, a risk score greater than a predefined threshold resulting from a count of DNS queries not meeting the minimum count threshold can result in performance of a corresponding risk mitigation action and a risk score greater than a predefined threshold resulting from a rate of DNS queries exceeding a maximum rate threshold can result in performance of a different corresponding risk mitigation action. The selected mitigation actions 107B can also be determined based on a degree to which a risk score is greater than a predefined threshold. For example, a risk score that greatly exceeds a threshold may trigger a stronger mitigation action than a risk score that only slightly exceeds the threshold.

Selection of mitigation actions can further be determined based upon multiple risk scores and risk thresholds. For example, certain mitigation actions can be activated only if two distinct risk scores (e.g., corresponding to DNS query count and DNS query rate) exceed their corresponding risk thresholds whereas other mitigation actions can be activated if only a single risk score exceeds a corresponding risk threshold.

Mitigation actions 107B can include, for example, rejecting the network communication, quarantining the network communication, removing a URL within the network communication, and/or modifying a URL within the network communication. For example, a malicious URL within an email can be replaced with an email that directs the end-user to a soft-landing page that alerts the user of the cybersecurity attack and provides guidance on how to avoid such attacks in the future. At the same time, or instead, as another mitigation action (by the administrator via a remote portal) a network administrator can be sent an alert informing them of the cybersecurity attack attempt and providing information of the user that clicked the malicious link. The administrator alert can be sent, for example, by email, provided via a management console, or accessed via a remote, web-based portal.

Mitigation actions can also include tagging a network communication for further analysis. This tagging can then be interpreted by a recipient's email client or other program and used to route the network communication to a further cybersecurity risk analysis system or other location for further analysis (e.g., for review by a cybersecurity analyst associated with the network, either locally or remotely). For example, a network communication can be transmitted to an isolated environment and a linked URL within the email (containing a domain identifier) can be activated to determine whether it results in any malicious scripts or other malware, in which case mitigation instructions can be sent to the mitigation controller. The isolated environment can be used to conduct instrumented and dynamic analysis on the contents of the network communication. For example, a hyperlink in the network communication can be activated and the effect of opening the hyperlink (including resulting processing behaviors) on the isolated environment's components can be monitored and analyzed dynamically. This can include monitoring background processes, memory usage, CPU load, and other indicators of a cybersecurity attack.

After determining an appropriate mitigation action, the mitigation controller 107 is configured to send instructions to interface 101 to implement the determined mitigation action either automatically or commanded by the administrator entered e.g., through a management interface. Interface 101 receives the instructions and implements the mitigation. For example, if the mitigation action includes rejection of an SMTP communication, then the interface 101 can respond to the network communication with a “connection refused” response to the SMTP communication.

The components of system 100 shown in FIG. 1 illustrate one possible configuration of a system for mitigating cybersecurity risk by analyzing domain name system (DNS) traffic. Other configurations can also be utilized. In an alternative embodiment, the DNS resolver 103 is not located within the intelligent DNS monitoring system 100 but rather within a remote system or service accessed over the computer network 120. In this case, the monitored DNS traffic between the DNS resolver 103 and the name servers 122 can be detected by the interface 101 and passed directly to the cyberattack detector 104, which can be configured to use domain identifier information in the monitored DNS traffic to match the DNS traffic to domain identifiers extracted from detected network communications by the domain extractor 102 and passed directly to the cyberattack detector 104 from domain extractor 102.

FIG. 5 illustrates a message flow diagram between components of the system for mitigating cybersecurity risk by analyzing domain name system (DNS) traffic rate and count according to an exemplary embodiment. As with other message flow diagrams, the chronological order of messages is reflected in descending order from the top of the diagram to the bottom of the diagram. Additionally, communications between adjacent components in the message flow diagram are indicated with solid arrows, whereas communications between non-adjacent components are indicated with dashed arrows.

As shown in FIG. 5, the interface 101 detects a network communication on a computer network and passed the network communication to the domain extractor 102. Domain extractor 102 then extracts a domain identifier from the network communication and passes the domain identifier to DNS resolver 103. The DNS resolver 103 then generates and transmits DNS queries back to interface 101, which forwards them to the relevant name servers (not shown), receives responses, and forwards the DNS responses back to DNS resolver 103.

Next, the monitored DNS traffic, which includes the DNS queries and the DNS responses is sent from DNS resolver 103 to cyberattack detector 104. The cyberattack detector then updates the relevant queue for the corresponding domain to add the received DNS queries to the queue. If the queues are not stored at the cyberattack detector 104 but at the database controller 105 or DNS database 106 then this step can be performed by a different component, such as the database controller 105.

The cyberattack detector 104 then extracts information from the monitored DNS traffic to generate a record identifier. The record identifier can optionally be generated solely from the domain identifier, such as by performing some transformation or hashing of the domain identifier. The record identifier can also be based on a combination of a domain identifier and a DNS record type or based on a combination of a domain identifier, DNS record type, and DNS response value contained within a DNS response in the monitored DNS traffic.

When generating the record identifier, the domain identifier and optionally the requested record type and/or the DNS response value can be combined to generate a combined value. This combination can be performed in a variety of ways. For example, the string values of each of the domain identifier, the requested record type, and the DNS response value can be concatenated or otherwise merged to produce a single combined value using a hash function which can be applied to the individual components prior to their combination or in a single combined value to generate the record identifier.

After generating the record identifier, the cyberattack detector 104 transmits a record update to the database controller 105 that is then passed from the database controller 105 to the DNS information database 106. As discussed previously, the record update includes information that is based on the monitored DNS traffic, such as the number of new DNS queries, and is configured to update a DNS metadata record corresponding to the generated record identifier within the DNS information database 106. For example, the update can update a count value associated with a particular DNS metadata record. The record update additionally specifies information to be returned from the DNS information database 106 in response to the update. For example, the record update can specify an update or increment to a count of DNS queries in a DNS metadata record and can further specify that the updated count of DNS queries should be returned in response to the DNS information database 106 receiving the update. The record update therefore includes a query component (such as an SQL SELECT command) in addition to an update component.

The record update is then transmitted to the DNS information database 106 by database controller 105, where the information included in the record update is used to update the relevant DNS metadata record indicated by the update. The query component of the update is then applied to the DNS information database 106 to select and return the requested information (such as the count of DNS queries) from the DNS information database 106 to the database controller 105 and then the cyberattack detector 104.

The cyberattack detector 104 then determines the rate of DNS queries associated with the domain identifier based on the corresponding queue, as discussed earlier. If the queues are not stored at the cyberattack detector 104 but at the database controller 105 or DNS database 106 then this step can be performed by a different component, such as the database controller 105, and the rate can be passed back to the cyberattack detector along with the count of DNS queries from the database controller 105.

The cyberattack detector 104 then conducts a risk assessment to determine a level of risk associated with the network communication. As discussed in greater detail with respect to FIGS. 1, 4, and 6, the risk assessment involves an assessment of the DNS query count and the DNS query rate in conjunction with a minimum count threshold and a maximum rate threshold.

The risk assessment results are then passed from the cyberattack detector 104 to the mitigation controller 107. As discussed with respect to FIG. 1, the mitigation controller 107 identifies appropriate mitigation actions based upon the risk assessment results and then sends commands to implement these mitigation actions to the interface 101, for example, in an alert.

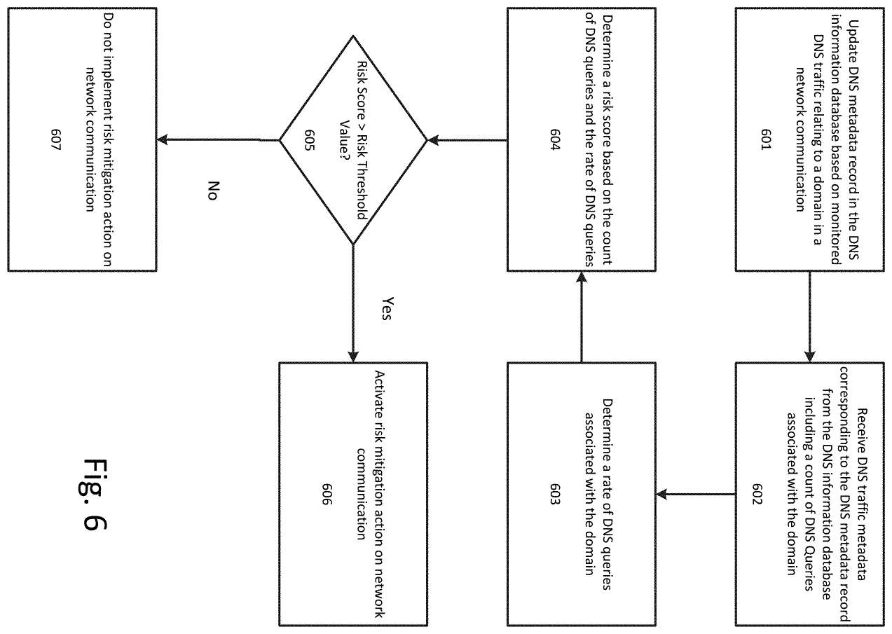

FIG. 6 illustrates a flowchart showing the steps performed by the cyberattack detector and mitigation controller to mitigate cybersecurity risk by analyzing domain name system (DNS) traffic rates and counts according to an exemplary embodiment.

At step 601 a DNS metadata record in the DNS information database is updated based on monitored DNS traffic relating to a domain in a network communication. As discussed earlier, this step involves the cyberattack detector transmitting the update, via the database controller, to the DNS information database.

At step 602 DNS traffic metadata corresponding to the DNS metadata record, including a count of DNS queries associated with the domain, is received from the DNS information database. Once again, this information is passed from the DNS information database to the cyberattack detector via the database controller.

At step 603 a rate of DNS queries associated with the domain is determined. As discussed earlier, this step is based on a domain-specific DNS query queue that stores DNS queries for a previous time period and can be performed by the cyberattack detector or alternatively by the database controller and passed back to the cyberattack detector.

At step 604 a risk score (or multiple risk scores or an aggregate risk score from multiple risk scores) are determined based on the count of DNS queries and the rate of DNS queries. This step is also performed by the cyberattack detector and involves the application of the minimum count threshold and the maximum rate threshold to the received count and rate information, as discussed earlier. For example, if a network communication includes a domain identifier that has never been observed before, then the update request will insert a new DNS metadata record into the DNS information database associated with that domain identifier. However, the occurrence count associated with the new record will be 1. The minimum count threshold can require that the count meet some minimum value (e.g., 100). In this case, the risk score can be determined based on the count and the minimum count threshold. For example, the risk assessment rule can determine the risk score as (Actual Occurrence Count)/(Minimum Count Threshold)=1/100=0.01. The risk threshold value for this risk score can be set to “1” meaning that risk scores less than 1 are flagged as corresponding to a cybersecurity risk. In this example, since the risk score is 0.01 and the risk threshold is 1, all new domain identifiers will be flagged as corresponding to a cybersecurity risk.

In another example, an aggregate risk score can be determined by computing a risk score associated with the count of DNS queries relative to the minimum count threshold, computing a second risk score associated with the rate of DNS queries relative the maximum rate threshold, and then aggregated the first and second risk scores through an arithmetic or other mathematical operation. Each risk score used to generate the aggregate can also be weighted separately, depending upon the domain identifier and/or user/administrator preferences. For example, an administrator can decide to weight the risk score associated with the maximum rate threshold lower than the risk score associated with the minimum count threshold. This could be beneficial if, for example, the system normally receives inconsistent traffic from several well-known domains but rarely receives any traffic from lesser known domains.

It is desirable to identify and flag newly observed domains as potential cybersecurity risks due to the use of new domains by cyber attackers. Since new domains frequently have little aggregate metadata and have not been flagged by existing systems (e.g., in blacklists), they are frequently used to launch cyberattacks on systems that are not specifically filtering for them. By identifying newly observed domains through the above-described techniques, the present system enables detection of cyberattacks even when a domain has not previously been flagged as suspicious.

If the risk score exceeds a corresponding cybersecurity risk threshold, then at step 606 a risk mitigation action is activated on the network communication. Otherwise, at step 607, no risk mitigation action is implemented on the network communication. Steps 606 and 607 can be performed by the mitigation controller, as discussed previously with respect to FIG. 1.

The above-mentioned techniques are not limited to single domain analysis. Similar to how DNS queries pertaining to a single domain are tracked and used to determine whether a minimum threshold has been met and a maximum threshold has not been exceeded, the system can also track DNS queries pertaining to pairs of domains, such as a sender domain and a receiver domain in an SMTP message. In this case, the DNS database can store a count of all DNS queries pertaining to the pair of domains. Any detected communications involving the pair of domains can be detected and the DNS database can be queried to determine if the count corresponding to that pair of domains exceeds or meets a minimum threshold and is less than or equal to a maximum rate threshold, using the techniques described herein. If not, mitigation action can be implemented on the network communication comprising the pair of domains.

The DNS traffic information and the risk assessment scores generated by the system can also be utilized for generating cybersecurity intelligence feeds. Specifically, the compiled DNS metadata records, including DNS query counts and DNS query rates and the risk scores calculated on the basis of the compiled DNS metadata traffic information can be provided, via periodic export or as a security content update service, to other systems for use in the assessment of domains and cybersecurity operations.

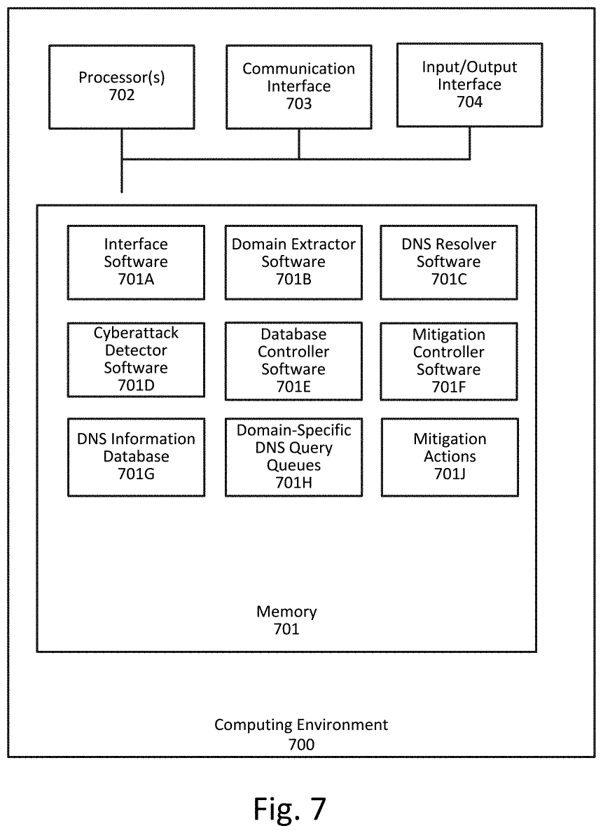

FIG. 7 illustrates computing environment for mitigating cybersecurity risk by analyzing domain name system (DNS) traffic rates and counts according to an exemplary embodiment. Computing environment 700 includes a memory 701 that is a non-transitory computer-readable medium and can be volatile memory (e.g., registers, cache, RAM), non-volatile memory (e.g., ROM, EEPROM, flash memory, etc.), or some combination of the two.

As shown in FIG. 7, memory 701 stores the interface software 701A, domain extractor software 701B, DNS resolver software 701C, cyberattack detector software 701D (which includes risk detection logic), database controller software 701E, mitigation controller software 701F (which includes the mitigation logic), DNS information database 701G, domain-specific query queues 701H, and mitigation actions 701J. In the embodiment where the DNS resolver is outside of the system, e.g., device 100, the DNS resolver software 701C can be excluded from memory. All of the software stored within memory 701 can be stored as a computer-readable instructions, that when executed by one or more processors, cause the processors to perform the functionality described with respect to FIGS. 1-6.

Computing environment 700 further includes one or more processors 702. The processors execute computer-executable instructions and can be a real or virtual processors. In a multi-processing system, multiple processors or multicore processors can be used to execute computer-executable instructions to increase processing power and/or to execute certain software in parallel. For example, domain extractor software 701B and interface software 701A can execute in parallel on different processors or processing cores.

The computing environment additionally includes a communication interface 703, such as a network interface, which is used to monitor network communications, communicate with devices on a computer network, collect data from devices on the network, and implement mitigation actions on network communications within the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Computing environment 700 further includes input and output interfaces 704 that allow users (such as system administrators) to provide input to the system and display or otherwise transmit information for display to users. For example, system administrators can utilize the input/output interface 704 to configure time periods used for rate determination, set cybersecurity risk thresholds, and/or configure mitigation actions. The current settings can also be displayed to users via the input/output interface 704. The display can include a graphical user interface (GUI) that presents options to users such as system administrators for configuring risk assessment rules, set cybersecurity risk thresholds, and mitigation actions. The GUI can also be configured to display alerts that are transmitted as a result of mitigation actions being transmitted.

An interconnection mechanism (shown as a solid line in FIG. 7), such as a bus, controller, or network interconnects the components of the computing environment 700.

Input and output interfaces 704 can be coupled to input and output devices. The input device(s) can be a touch input device such as a keyboard, mouse, pen, trackball, touch screen, or game controller, a voice input device, a scanning device, a digital camera, remote control, or another device that provides input to the computing environment. The output device(s) can be a display, television, monitor, printer, speaker, or another device that provides output from the computing environment 700.

The computing environment 700 can additionally utilize a removable or non-removable storage, such as magnetic disks, magnetic tapes or cassettes, CD-ROMs, CD-RWs, DVDs, USB drives, or any other medium which can be used to store information and which can be accessed within the computing environment 700.

The computing environment 700 can be a network device, cyber-security appliance, personal computer, client device, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. Elements of the described embodiment shown in software can be implemented in hardware and vice versa.

In view of the many possible embodiments to which the principles of our invention can be applied, we claim as our invention all such embodiments as can come within the scope and spirit of the following claims and equivalents thereto.

We claim:

1. A method executed by one or more computing devices for mitigating cybersecurity risk, the method comprising:
detecting a network communication propagated over a computer network, the network communication comprising a domain identifier;
determining domain name system (DNS) traffic metadata corresponding to the domain identifier, the DNS traffic metadata being determined based on monitored DNS traffic associated with the domain identifier to one or more DNS servers, wherein the DNS traffic metadata comprises a count of DNS queries associated with the domain identifier and a rate of DNS queries associated with the domain identifier;
determining whether the count of DNS queries and the rate of DNS queries are indicative of a cybersecurity risk; and
activating one or more mitigation actions based at least in part on a determination that the count of DNS queries and the rate of DNS queries are indicative of a cybersecurity risk.

2. The method of claim 1, wherein determining DNS traffic metadata corresponding to the domain identifier comprises:
storing a DNS metadata record in memory and associated with the domain identifier, the DNS metadata record comprising the count of DNS queries associated with the domain identifier and being updated based at least in part on monitored DNS traffic associated with the domain identifier to and from the one or more DNS servers;
querying the DNS metadata record using a record identifier generated from the domain identifier to retrieve the count of DNS queries associated with the domain identifier; and
generating the rate of DNS queries associated with the domain identifier by counting a quantity of records in a queue corresponding to the domain identifier, the queue storing records corresponding to previous DNS queries associated with the domain identifier over a prior time period.

3. The method of claim 2, wherein the prior time period is determined based one or more of: administrator input, a default value, or the domain identifier.

4. The method of claim 1, further comprising:
monitoring DNS traffic to and from the one or more DNS servers relating to the domain identifier, the DNS traffic including one or more DNS queries; and
updating the count of DNS queries associated with the domain identifier in a DNS metadata record stored in memory and associated with the domain identifier based at least in part on the monitored DNS traffic.

5. The method of claim 1, wherein determining whether the count of DNS queries and the rate of DNS queries are indicative of a cybersecurity risk comprises:
determining whether the count of DNS queries exceeds or meets a minimum threshold;
in response to determining that the count of DNS queries exceeds or meets the minimum threshold, determining whether the rate of DNS queries exceeds a maximum rate threshold, the maximum rate threshold being determined based at least in part on the count of DNS queries and a time period; and
determining that the count of DNS queries and the rate of DNS queries are indicative of a cybersecurity risk based at least in part on a determination that the count of DNS queries does not exceed or meet the minimum threshold or a determination that the rate of DNS queries exceeds the maximum rate threshold.

6. The method of claim 5, wherein the maximum rate threshold is determined by:
determining a maximum count value based at least in part on the count of DNS queries;
determining the time period based one or more of: a user input, a default value, or the domain identifier; and
determining the maximum rate threshold based at least in part on the maximum count value and the time period.

7. The method of claim 1, wherein the one or more mitigation actions comprise one or more of: generating an alert and transmitting the generated alert to a security administrator, rejecting the network communication, dropping the network communication, quarantining the network communication, removing a URL within the network communication, or modifying a URL within the network communication.

8. The method of claim 1, wherein the network communication comprises one of: a Simple Mail Transfer Protocol (SMTP) handshake request, an SMTP email message, or a web browser request.

9. An apparatus for mitigating cybersecurity risk, the apparatus comprising:
one or more processors; and
one or more memories operatively coupled to at least one of the one or more processors and having instructions stored thereon that, when executed by at least one of the one or more processors, cause at least one of the one or more processors to:
detect a network communication propagated over a computer network, the network communication comprising a domain identifier;
determine domain name system (DNS) traffic metadata corresponding to the domain identifier, the DNS traffic metadata being determined based on monitored DNS traffic associated with the domain identifier to one or more DNS servers, wherein the DNS traffic metadata comprises a count of DNS queries associated with the domain identifier and a rate of DNS queries associated with the domain identifier;
determine whether the count of DNS queries and the rate of DNS queries are indicative of a cybersecurity risk; and
activate one or more mitigation actions based at least in part on a determination that the count of DNS queries and the rate of DNS queries are indicative of a cybersecurity risk.

10. The apparatus of claim 9, wherein the instructions that, when executed by at least one of the one or more processors, cause at least one of the one or more processors to determine DNS traffic metadata corresponding to the domain identifier further cause at least one of the one or more processors to:
storing a DNS metadata record in memory and associated with the domain identifier, the DNS metadata record comprising the count of DNS queries associated with the domain identifier and being updated based at least in part on monitored DNS traffic associated with the domain identifier to and from the one or more DNS servers;
querying the DNS metadata record using a record identifier generated from the domain identifier to retrieve the count of DNS queries associated with the domain identifier; and
generating the rate of DNS queries associated with the domain identifier by counting a quantity of records in a queue corresponding to the domain identifier, the queue storing records corresponding to previous DNS queries associated with the domain identifier over a prior time period.

11. The apparatus of claim 9, wherein at least one of the one or more memories has further instructions stored thereon that, when executed by at least one of the one or more processors, cause at least one of the one or more processors to:
monitoring DNS traffic to and from the one or more DNS servers relating to the domain identifier, the DNS traffic including one or more DNS queries; and
updating the count of DNS queries associated with the domain identifier in a DNS metadata record stored in memory and associated with the domain identifier based at least in part on the monitored DNS traffic.

12. The apparatus of claim 9, wherein the instructions that, when executed by at least one of the one or more processors, cause at least one of the one or more processors to determine whether the count of DNS queries and the rate of DNS queries are indicative of a cybersecurity risk further cause at least one of the one or more processors to:
determining whether the count of DNS queries exceeds or meets a minimum threshold;
in response to determining that the count of DNS queries exceeds or meets the minimum threshold, determining whether the rate of DNS queries exceeds a maximum rate threshold, the maximum rate threshold being determined based at least in part on the count of DNS queries and a time period; and
determining that the count of DNS queries and the rate of DNS queries are indicative of a cybersecurity risk based at least in part on a determination that the count of DNS queries does not exceed or meet the minimum threshold or a determination that the rate of DNS queries exceeds the maximum rate threshold.

13. The apparatus of claim 9, wherein the one or more mitigation actions comprise one or more of: generating an alert and transmitting the generated alert to a security administrator, rejecting the network communication, dropping the network communication, quarantining the network communication, removing a URL within the network communication, or modifying a URL within the network communication.

14. The apparatus of claim 9, wherein the network communication comprises one of: a Simple Mail Transfer Protocol (SMTP) handshake request, an SMTP email message, or a web browser request.

15. At least one non-transitory computer-readable medium storing computer-readable instructions that, when executed by one or more computing devices, cause at least one of the one or more computing devices to:
detect a network communication propagated over a computer network, the network communication comprising a domain identifier;
determine domain name system (DNS) traffic metadata corresponding to the domain identifier, the DNS traffic metadata being determined based on monitored DNS traffic associated with the domain identifier to one or more DNS servers, wherein the DNS traffic metadata comprises a count of DNS queries associated with the domain identifier and a rate of DNS queries associated with the domain identifier;
determine whether the count of DNS queries and the rate of DNS queries are indicative of a cybersecurity risk; and
activate one or more mitigation actions based at least in part on a determination that the count of DNS queries and the rate of DNS queries are indicative of a cybersecurity risk.

16. The at least one computer-readable medium of claim 15, wherein the instructions that, when executed by at least one of the one or more computing devices, cause at least one of the one or more computing devices to determine DNS traffic metadata corresponding to the domain identifier further cause at least one of the one or more computing devices to:
storing a DNS metadata record in memory and associated with the domain identifier, the DNS metadata record comprising the count of DNS queries associated with the domain identifier and being updated based at least in part on monitored DNS traffic associated with the domain identifier to and from the one or more DNS servers;
querying the DNS metadata record using a record identifier generated from the domain identifier to retrieve the count of DNS queries associated with the domain identifier; and
generating the rate of DNS queries associated with the domain identifier by counting a quantity of records in a queue corresponding to the domain identifier, the queue storing records corresponding to previous DNS queries associated with the domain identifier over a prior time period.

17. The at least one computer-readable medium of claim 15, further storing computer-readable instructions that, when executed by at least one of the one or more computing devices, cause at least one of the one or more computing devices to:
monitoring DNS traffic to and from the one or more DNS servers relating to the domain identifier, the DNS traffic including one or more DNS queries; and
updating the count of DNS queries associated with the domain identifier in a DNS metadata record stored in memory and associated with the domain identifier based at least in part on the monitored DNS traffic.

18. The at least one computer-readable medium of claim 15, wherein the instructions that, when executed by at least one of the one or more computing devices, cause at least one of the one or more computing devices to determine whether the count of DNS queries and the rate of DNS queries are indicative of a cybersecurity risk further cause at least one of the one or more computing devices to:
determining whether the count of DNS queries exceeds or meets a minimum threshold;
in response to determining that the count of DNS queries exceeds or meets the minimum threshold, determining whether the rate of DNS queries exceeds a maximum rate threshold, the maximum rate threshold being determined based at least in part on the count of DNS queries and a time period; and
determining that the count of DNS queries and the rate of DNS queries are indicative of a cybersecurity risk based at least in part on a determination that the count of DNS queries does not exceed or meet the minimum threshold or a determination that the rate of DNS queries exceeds the maximum rate threshold.

19. The at least one computer-readable medium of claim 15, wherein the one or more mitigation actions comprise one or more of: generating an alert and transmitting the generated alert to a security administrator, rejecting the network communication, dropping the network communication, quarantining the network communication, removing a URL within the network communication, or modifying a URL within the network communication.

20. The at least one computer-readable medium of claim 15, wherein the network communication comprises one of: a Simple Mail Transfer Protocol (SMTP) handshake request, an SMTP email message, or a web browser request.
